(19) United States
(12) Patent Application Publication
(10) Pub. No.: US 2015/0285312 A1
(43) Pub. Date: Oct. 8, 2015

(54) ISOLATOR FOR USE WITH MGU THAT IS USED TO ASSIST OR START ENGINE THROUGH AND ENDLESS DRIVE MEMBER

(71) Applicant: LITENS AUTOMOTIVE PARTNERSHIP, Woodbridge (CA)

(72) Inventors: Warren J. Williams, Oakville (CA); Andrew M. Boyes, Aurora (CA); Gary J. Spicer, Mississauga (CA)

(73) Assignee: LITENS AUTOMOTIVE PARTNERSHIP, Woodbridge, ON (CA)

(21) Appl. No.: 14/435,043

(22) PCT Filed: Oct. 15, 2013
(86) PCT No.: PCT/CA2013/000880

§ 371 Date: Apr. 10, 2015

Related U.S. Application Data
(60) Provisional application No. 61/713,463, filed on Oct. 12, 2012.

(51) Int. Cl. F16D 3/12; F16H 55/36; F16F 15/121

(52) U.S. Cl. CPC F16D 3/12; F16F 15/121; F16H 55/36; F16H 2055/366

(57) ABSTRACT

In an aspect the invention is directed to an isolator comprising a shaft connector that is connectable with a shaft of a motive device, a first rotary drive member that is operatively engageable with at least one second rotary drive member, a first isolation spring and a second isolation spring. The first rotary drive member and the shaft connector are rotatable about an isolator axis. The motive device may be an engine (and thus the shaft may be a crankshaft), or a motor for assisting an engine, for example. Examples of motors for assisting engines include motor/generator units (MGU's) that can operate as a generator when driven to rotate mechanically, and can operate as a motor when driven to rotate electrically. The first isolation spring is positioned to transfer a torque from the first rotary drive member to the shaft connector. The second isolation spring is positioned to transfer a torque from the shaft connector to the first rotary drive member. The first and second isolation springs are axially offset from one another.

### CROSS-REFERENCE TO RELATED APPLICATIONS

This application claims priority to U.S. Provisional Patent Application No. 61/713,463 filed Oct. 12, 2012 the contents of which are incorporated herein in their entirety.

### FIELD

This disclosure relates to isolators and in particular to an isolator that is used on an MGU in a vehicle in which the engine can be started or assisted by the endless drive member (e.g. an engine equipped with a belt-alternator start (BAS) drive system).

### BACKGROUND

Isolators are known devices that are installed on some belt-driven accessories for reducing the transmission of torsional vibrations from the crankshaft to a belt driven by the crankshaft. While a traditional isolator is useful in many vehicular applications, some isolators do not perform ideally in applications wherein the belt is sometimes used to transmit torque to the crankshaft, for example as part of a Belt-Alternator Start (BAS) drive system wherein an electric motor is used to drive the belt in order to drive the crankshaft for the purpose of starting the engine.

It would be advantageous to provide an isolator that is configured for use in vehicles with BAS drive systems or the like.

### SUMMARY

In an aspect the invention is directed to an isolator comprising a shaft connector that is connectable with a shaft of a motive device, a first rotary drive member that is operatively engageable with at least one second rotary drive member, a first isolation spring and a second isolation spring. The first rotary drive member and the shaft connector are rotatable about an isolator axis. The motive device may be an engine (and thus the shaft may be a crankshaft), or a motor for assisting an engine, for example. Examples of motors for assisting engines include motor/generator units (MGU's) that can operate as a generator when driven to rotate mechanically, and can operate as a motor when driven to rotate electrically. The first isolation spring is positioned to transfer a torque from the first rotary drive member to the shaft connector. The second isolation spring is positioned to transfer a torque from the shaft connector to the first rotary drive member. The first and second isolation springs are axially offset from one another.

In another aspect the invention is directed to an isolator, comprising a shaft connector that is connectable with a shaft of a motive device, a first rotary drive member that is operatively engageable with at least one second rotary drive member, wherein the first rotary drive member and the shaft connector are rotatable about an isolator axis, and first and second isolation springs. The first isolation spring is a helical torsion spring and is positioned to transfer a torque from the first rotary drive member to the shaft connector. The second isolation spring is an elastomeric spring and is positioned to transfer a torque from the shaft connector to the first rotary drive member.

In yet another aspect, the invention is directed to an isolator, comprising a shaft connector that is connectable with a shaft of a motive device, a first rotary drive member that is operatively engageable with at least one second rotary drive member, wherein the first rotary drive member and the shaft connector are rotatable about an isolator axis, first and second isolation springs, and an anti-rattle spring. The first isolation spring is a helical torsion spring and is positioned to transfer a torque from the first rotary drive member to the shaft connector. The second isolation spring is positioned to transfer a torque from the shaft connector to the first rotary drive member. The anti-rattle spring is positioned to apply a force urging the pulley away from the torsion spring to reduce a force of impact between the pulley, the torsion spring and the shaft connector at the onset of torque transfer from the rotary drive member to the shaft connector.

### BRIEF DESCRIPTION OF THE DRAWINGS

The foregoing and other aspects will now be described by way of example only with reference to the attached drawings, in which:

FIG. 1 is a side view of an engine in a vehicle containing an isolator on a crankshaft, in accordance with an embodiment of the present invention;

FIG. 2 is an exploded perspective view of the isolator shown in FIG. 1;

FIG. 3 is another exploded perspective view of the isolator shown in FIG. 1;

FIG. 4 is a perspective cutaway view of the isolator shown in FIG. 1, illustrating a torque path through the isolator from a shaft of a motor/generator unit to a belt;

FIG. 5 is a perspective cutaway view of the isolator shown in FIG. 1, illustrating a torque path through the isolator from a belt to a shaft of a motor/generator unit;

FIG. 6 is a side view of an isolator spring and a support member from the isolator shown in FIG. 1 for use in transferring torque from the belt to the engine crankshaft; and

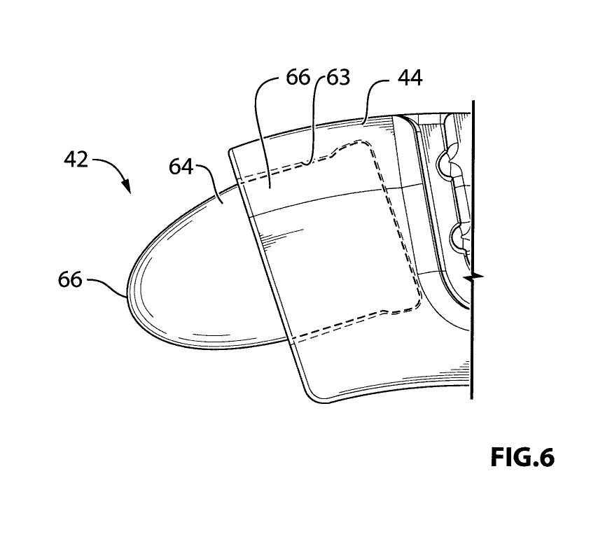

FIG. 7 illustrates the torque transmitted through the isolator in relation to the relative angular displacement between a pulley and the crankshaft.

### DETAILED DESCRIPTION OF EXAMPLE EMBODIMENTS

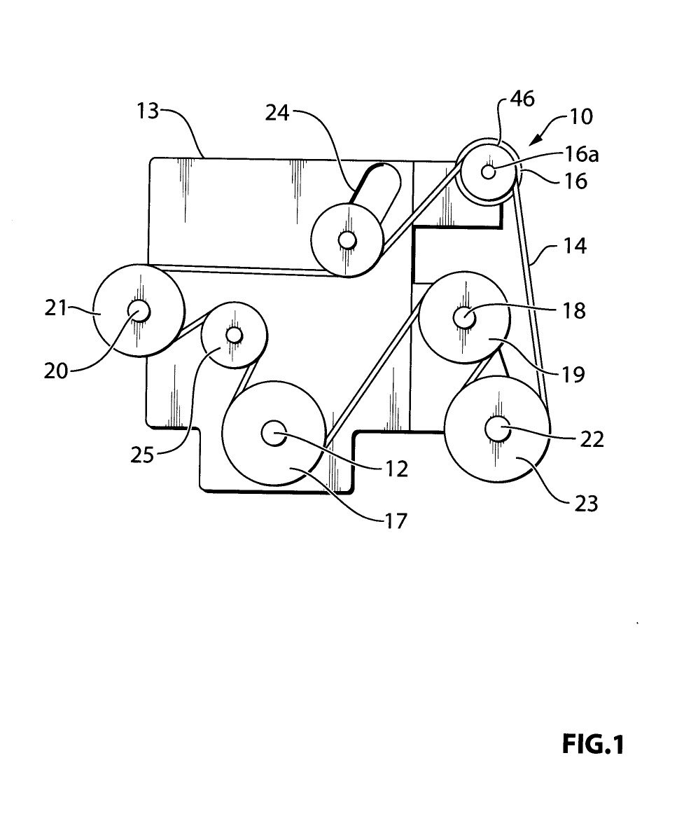

Reference is made to FIG. 1, which shows an embodiment of an isolator 10 positioned for use between a shaft 16a from a motive device 16, such as a motor-generator unit (MGU) and an accessory drive belt 14 that is driven by a crankshaft 12 on a vehicle engine 13 (through a pulley 17). The belt 14 may be used to transfer torque from the crankshaft 12 to drive accessories such as the motor-generator unit 16, via pulley 46, a power steering pump 18 via pulley 19, a water pump 20, via pulley 21, an air conditioning compressor 22 via pulley 23, and/or any other suitable accessories. A belt tensioner is shown at 24 for maintaining belt tension, and an idler are shown at 25 for maintaining a suitable amount of belt wrap on selected components. The terms ‘pulley’ and ‘belt’ are used for convenience, however it will be understood that the belt may be any suitable endless drive member and the pulleys may instead be any suitable rotary drive member that can transfer power to and from the endless drive member.

In some vehicles, such as some hybrid vehicles, the engine 13 may be stopped temporarily in some situations (such as when the vehicle is stopped at a stoplight) and may be started again through the accessory drive belt 14. In such situations, the MGU 16 can be operated as a generator when the engine 13 is running so as to generate electricity for storage in a vehicle battery (not shown), and can be operated as an electric motor to drive the crankshaft 12 via the belt 14, enabling the engine 13 to be started via the belt 14 (i.e. via a BAS drive system). Instead of being an MGU, the motive device 16 may be an electric, hydraulic or pneumatic motor for use in starting the engine 13. The MGU, or the dedicated other motor may be referred to generally as a supplemental motor, as it is a supplemental means for providing power to the crankshaft 12, as distinguished from the engine 13 itself which is the main means for providing power to the crankshaft 12. Instead of, or in addition to, being used to start the engine 13, the supplemental motor may be used to provide a power boost to the engine 13 via the belt 14.

The isolator 10 is suited for use on any shaft of any rotating member, but is particularly suited for use on the shaft 16a of the MGU 16 for use with an engine that can be started or boosted in power by the MGU 16 via the belt or other endless drive member 14, and an engine that is configured to be started or boosted in power by an MGU or motor via a gear drive or other type of operative connection between a plurality of rotary drive members.

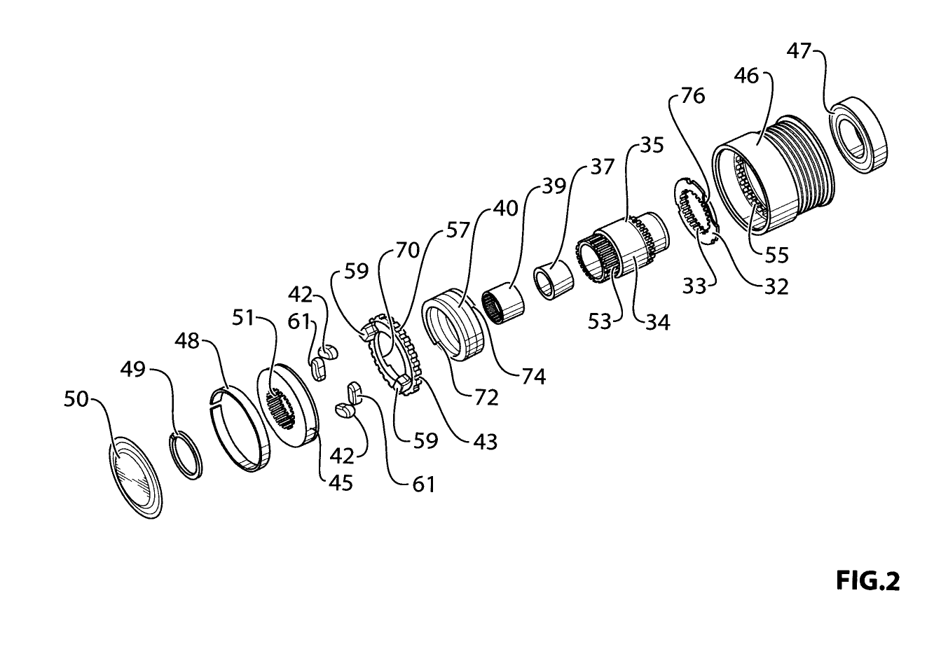

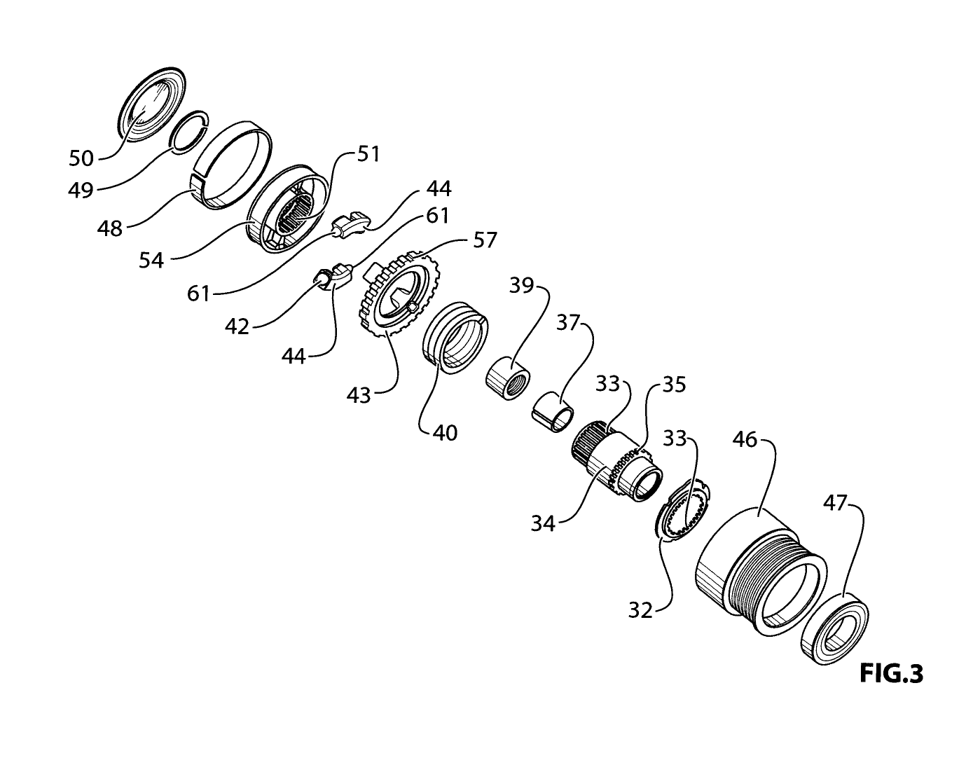

Referring to the exploded views in FIGS. 2 and 3, the isolator 10 includes a first driver 32 that mounts to an alternator shaft 16 of FIG. 1 via a shaft extension 34, which may also be referred as a shaft mounting member 34 since it does not necessarily have to extend the shaft 16. In particular the first driver 32 may include a radially inner surface with splines 33 thereon, which engage corresponding splines 35 on a radially outer surface of the shaft extension 34 thereby fixing the first driver 32 rotationally with the shaft extension 34. The shaft extension 34 mounts to the shaft 16a in any suitable way.

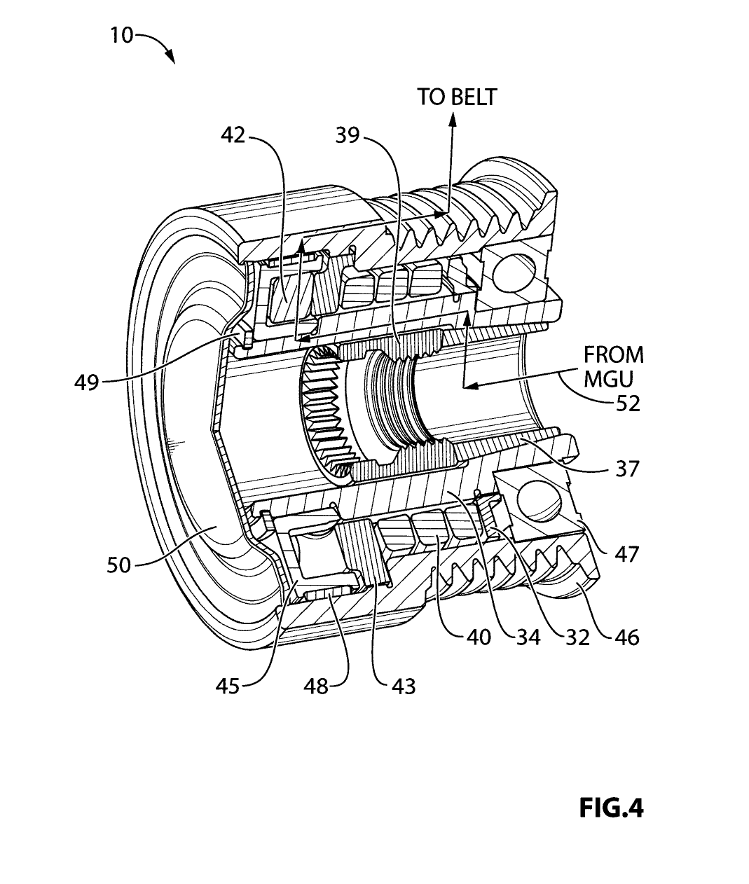

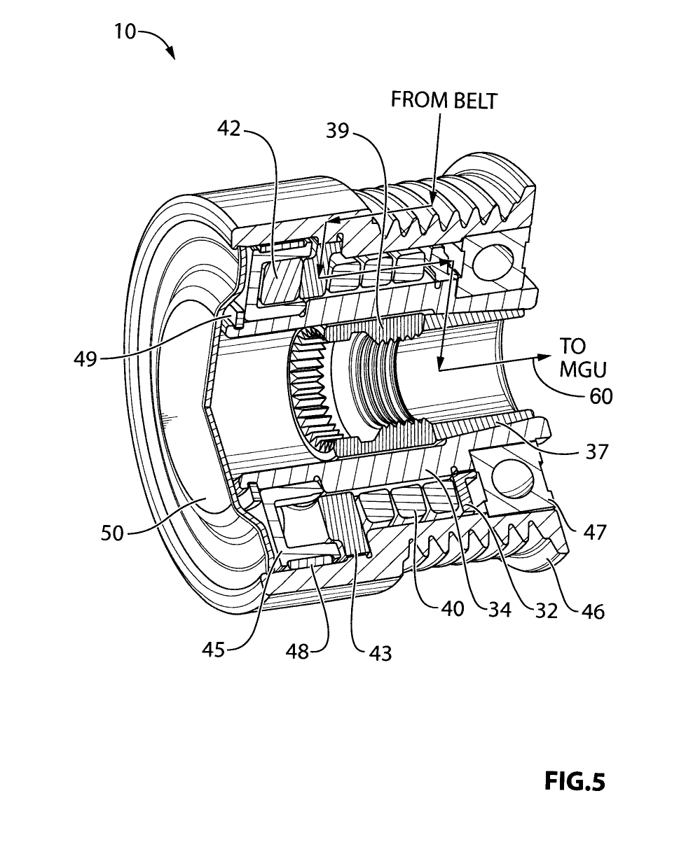

The isolator 10 further includes a split bushing 37 and a nut 39, a first isolation spring 40, a plurality of second isolation springs 42, support members (FIG. 3), shown at 44 for the second isolation springs 42, a second driver 45, a third driver 43, a plurality of anti-rattle springs 61, a pulley or other rotary drive member 46 with splines 55 thereon that engage splines 57 on the third driver 43 (thereby fixing the third driver 43 rotationally with the rotary drive member 46), a bearing 47, a bushing 48, a clip 49 for holding the bearing 47 in place on the shaft extension 34 (as shown in FIGS. 4 and 5), and a seal cover 50 that mounts for rotation with the pulley 46 to inhibit dust and moisture from entering the isolator 10.

The rotary drive member 46 is a first rotary drive member and is operatively connected to at least one second rotary drive member (in this instance a plurality of second rotary drive members including the alternator or MGU pulley 17, the power steering pump pulley 19, the water pump pulley 21 and the air conditioning compressor pulley 23. In the example shown in FIG. 1, the rotary drive member 46 is a pulley and is operatively connected to the second rotary drive members via the belt 14. However, in other embodiments, the rotary drive member 46 may, for example, be a first gear that is operatively connected to one or more second gears, such as, for example, an MGU gear, a power steering pump gear, a water pump gear and an air conditioning compressor gear, via direct or indirect engagement.

The second driver 45 is configured for holding the second isolation springs 42 and the support members 44 and for driving the second isolation springs 42, and has splines 51 thereon that engage splines 53 on the shaft extension 34, thereby fixing the second driver 45 rotationally with the shaft extension 34. The shaft extension 34, the first driver 32 and the second driver 45 may together be referred to as a shaft connector, since they rotate together as one element, and as one element with the alternator (or MGU) shaft 16a.

The nut 39 mounts to the end of the alternator shaft 16a via a threaded connection. The nut 39 bears down on the split bushing 37 which wedges on a conical wall in the interior of the shaft extension 34 thereby locking the shaft extension 34 to the alternator shaft 16a.

The bearing 47 is engaged between the pulley 46 and the shaft extension 34 and permits relative rotation or angular movement therebetween. The bushing 48 permits relative rotation or angular movement between the pulley 46 and the second driver 45.

When the isolator 10 operates in a ‘normal’ or ‘power-from-engine’ mode whereby the alternator shaft 16 is driven by the belt 14, the torque path through the isolator 10 is as shown by the arrows 60 shown in FIG. 5. As shown, the pulley 46 is driven by the belt 14 (FIG. 1), and in turn drives the first isolation spring 40 through the third driver 43. In particular, the third driver member 43 has a first end drive surface 70 (FIG. 2) is abuttable with a first end 72 of the first isolation spring 40. The first isolation spring 40 in turn drives the first driver 32. More particularly, the second end of the first isolation spring 40, which is shown at 74, is abuttable with a second end drive surface 76 on the first driver 32. The first driver 32 in turn drives the alternator shaft 16 (FIG. 1) through the shaft extension 34.

When the third driver 43 drives the first isolation spring 40, there is some angular movement of the third driver 43 relative to the shaft extension 34. Because the second driver 45 rotates with the shaft extension 34, the movement of the third driver member 43 causes it to rotate relative to the second driver 45, and, optionally to cause lugs 59 on the third driver 43 to compress by some amount the anti-rattle springs 61 so as to reduce any rattling that might otherwise occur. The anti-rattle springs 61 are thus positioned to apply a force urging the pulley 46 away from the torsion spring 40 to reduce a force of impact between the pulley 46, the torsion spring 40 and the shaft connector at the onset of torque transfer from the rotary drive member to the shaft connector.

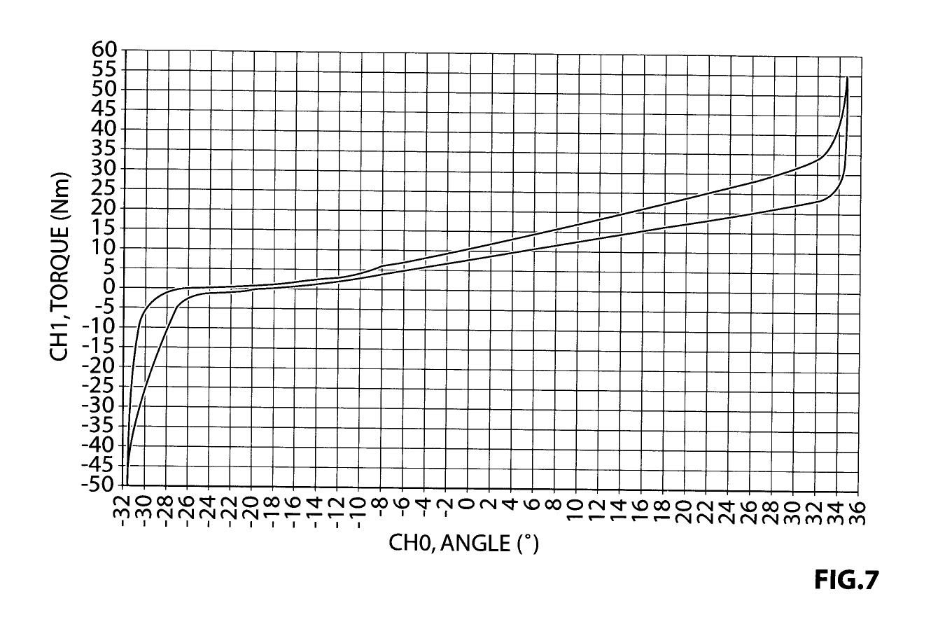

The response of the first isolation spring 40 may be generally linear for an initial portion of its flexure or displacement. In embodiments wherein the first isolation spring 40 is a helical torsion spring that expands when transferring torque from the belt 14 after the initial displacement is done the coils of the spring 40 may engage the inner wall of the pulley 46, thereby limiting further expansion of the coils. As a result, the spring force of the spring 40 increases non-linearly (in a greater-than-linear manner). This can be seen in the far-right portion of the spring force-to-displacement curve shown in FIG. 7.

It will be noted that when the isolator 10 is at rest, both the first isolation spring 40 and the second isolation springs 42 will be in a state of displacement away from their respective neutral positions. In the embodiment shown, this would mean that there will be some compression in both the first and second isolation springs 40 and 42.

When the isolator 10 operates in a BAS, ‘boost’ or ‘power-from-supplemental-motor’ mode whereby the alternator shaft 16 drives the belt 14 and the belt 14 drives the crankshaft 12, the torque path through the isolator 10 is as shown by the arrows 52 shown in FIG. 4. As shown, the crankshaft extension 34 is driven by the alternator shaft 16 (FIG. 1), and in turn drives the second isolation springs 42 through the second driver 45 and through the support members 44. The second isolation springs 42 in turn drive the third driver 43, which in turn drives the pulley 46. Because the first end drive surface 70 is not fixedly connected with the first end 72 of the first isolation spring 40, the third driver 43 can be driven by the second isolation springs 42 and the drive surface 70 may simply be rotated away from the first end 74 of the first isolation spring 40. When torque is transferred again from the pulley 46 to the shaft 16a, the anti-rattle springs 61 assist in reducing impact noise as the surface 70 returns into contact with the first end 72 of the first isolation spring 40.

The second isolation springs 42 may have any suitable configuration. For example, the second isolation springs 42 may be made from a rubber material, a closed-cell foam, or they may alternatively be coil springs (e.g. helical compression springs). In some embodiments the second isolation springs 42 may be configured so that they provide a linear response in terms of a spring force-displacement relationship, or alternatively, they may be configured so as to provide a non-linear response to displacement. For example, as shown in the magnified view shown in FIG. 7, in some embodiments the second isolation springs 42 may include a body portion 62 that has a substantially constant cross-sectional area (and which may be generally cylindrical), and a contact head that is engageable with the crankshaft driver 32 that tapers towards a free end 66 of the second isolation spring 42. The particular shape of the contact head 64 may be generally ellipsoidal. The contact head 64 may alternatively have some other shape such as a generally conical shape with a rounded free end.

As a result of the shape of the contact head 64, the initial compression of the second isolation springs 42 is linear but the spring force increases relatively slowly with displacement. This reduces the likelihood of impact noises being emitted from the isolator 10 during impact of the crankshaft driver 32 and the isolation springs 42. Such impacts can occur during certain events as will be discussed further below. After the initial amount of compression has taken place, further compression of the isolation spring 42 causes radial expansion of the body portion 62, which is constrained by the wall of the support member 44, shown at 63. The shape of the wall 63 may be tailored as desired to generate a desired increase in the spring rate of the springs 42. In some embodiments, the springs 42 and the wall 63 may be configured such that the springs 42 have a force-displacement relationship wherein displacement of each second isolation spring 42 over a selected range of movement away from a neutral position generates a greater-than-linear increase in biasing force. Any other way of generating a non-linear (e.g. a greater than linear) force response to displacement may be utilized, such as any of the ways described above for the first isolation springs 40.

By providing a spring force that increases non-linearly, the isolator 10 can inhibit situations where the MGU shaft 16a causes the isolation springs 42 to fully compress, or bottom out permitting effectively a direct engagement between the second driver 45, the support members 44 and the third driver 43, which can lead to high stresses on many components including components of the isolator 10 and the alternator shaft 16 itself, and which can lead to noise and vibration being emitted from the isolator 10.

During compression of the second isolation springs 42, in embodiments wherein they are rubber or closed-cell foam springs or the like, the member 42 may expand radially and will rub the wall 63 of the support member 44 as the member 42 compresses, particularly as the body portion 62 compresses. In such embodiments, the rubbing of the body portion 62 against the support member 44 may generate some amount of damping.

While two second isolation springs 42 are shown, there could alternatively be as few as one isolation spring 42, or any other number of isolation springs 42. In cases where a plurality of isolation springs 42 are provided, they may have polar symmetry about the axis of rotation of the pulley 46 (i.e. they may be spaced equally about the axis of rotation of the pulley 46).

The anti-rattle springs 61 may have a similar shape and construction to the second isolation springs 42. Optionally, the anti-rattle springs 61 may have a different spring rate than the springs 42 however.

Events that can cause separation of the third driver 43 (more accurately, separation of the lugs 59 on the third driver 43) from the second isolation springs 42 may occur in several ways. During operation of the isolator 10, particularly during operation in the ‘normal’ mode, it is possible that the driver 32 will receive a sudden torque increase from the belt 14 due to torsional vibrations at the crankshaft 12 as described above. Additionally an event can occur where there is a sudden increase in resistance to movement from the shaft 16a, such as when the MGU 16 is used to generate electricity. Depending on the severity of such events the third driver 43 may be driven by the pulley 46 away from the second isolation springs 42. As the torque at the crankshaft 12 is reduced or as the load at the accessories is reduced, the third driver 43 returns to engage the isolation springs 42 and thus there is some amount of impact between the driver 32 and the isolation springs 42. It is advantageous to configure the second isolation springs 42 to provide a relatively low resistance to compression during their impacts from the driver 32. In some embodiments, such as embodiments where coil compression springs or closed cell foam springs are used for the isolation springs 42, the isolation springs 42 may have sufficient amounts of compression available to them that they can be sufficient long so that they are always in contact with the driver 32 even during high torque or high resistance events described above.

FIG. 7 illustrates the biasing force to displacement relationship for the isolator 10, based on the angular position of the driver 32 relative to the pulley 46. The response during compression of the first isolation spring 40 may be relatively linear as can be seen by the right portion of the curve. The response during compression of the second isolation springs 42 may be linear (and small) initially and may then increase (in the negative direction) in a greater-than-linear manner after some selected amount of displacement, as shown by the left portion of the curve. Some hysteresis may also be observed in FIG. 7, as a result of damping that may result from engagement between the coils of the spring 40 with the pulley wall and from the aforementioned rubbing of the isolation springs 42 with the support members 44.

By providing separate first and second isolation springs 42, the response of the isolator 10 can be tailored in different ways when the crankshaft 12 is driving the belt 14 versus when the belt 14 is driving the crankshaft 12 so as to address the different torsional events that can occur in each situation. In some embodiments, the second isolation springs 42 may be configured to provide shock absorption during engine startup via the belt, whereas the first isolation springs 40 may be configured to provide isolation from torsional vibrations and the like.

The isolator 10 has an isolator axis A that is defined by the center of rotation of the shaft extension 34 and the pulley 46. It will be noted that the second isolation springs 42 are axially offset from the first isolation spring 40. This is advantageous in that it permits the diameter of the pulley 46 to be kept relatively small. This is desirable for use on accessories such as the alternator or the MGU 16 on some vehicles where it is desired for the pulley 46 to be generally relatively small so as to have a selected drive ratio relative to the crankshaft pulley 17. Furthermore, by combining the axial offset of the isolation springs 40 and 42 with the use of a torsion spring as the first isolation spring 40, the overall diameter of the isolator 10 may further be kept relatively small.

It will further be noted that the use of a torsion spring as spring 40 in combination with the elastomeric spring as the spring 42 also contributes to maintaining a small diameter for the isolator 10 and therefore for the pulley 46.

In general, wherever the use of splines has been described, it is alternatively possible to use some other means for holding two components fixed or at least rotationally fixed together, such as by welding, by press-fit or by any other suitable means.

In the embodiments shown in the figures, the rotary drive members 46 and 346 are shown to be pulleys, however, as noted above the rotary drive member could be another type of rotary drive member, such as, for example, a gear for use in an engine assembly where the crankshaft drives accessories via a system of gears.

The above-described embodiments are intended to be examples only, and alterations and modifications may be carried out to those embodiments by those of skill in the art.

1. An isolator, comprising:
a shaft connector that is connectable with a shaft of a motive device;
a first rotary drive member that is operatively engageable with at least one second rotary drive member, wherein the rotary drive member and the shaft connector are rotatable about an isolator axis;
a first isolation spring that is positioned to transfer a torque from the first rotary drive member to the shaft connector; and
a second isolation spring that is positioned to transfer a torque from the shaft connector to the first rotary drive member, and has a spring rate that is different than that of the first isolation spring,
wherein the first and second isolation springs are axially offset from one another.

2. An isolator as claimed in claim 1, wherein the second isolation spring is one of a plurality of second isolation springs that exhibit polar symmetry about an axis of rotation of the first rotary drive member and the shaft connector.

3. An isolator as claimed in claim 1, wherein the first isolation spring is a helical torsion spring.

4. An isolator as claimed in claim 1, wherein the second isolation spring is made from an elastomeric material.

5. An isolator as claimed in claim 1, wherein the second isolation spring is made from rubber.

6. An isolator as claimed in claim 1, wherein the second isolation spring is made from a closed cell foam material.

7. An isolator as claimed in claim 1, wherein the second isolation spring is configured to have a force-displacement relationship such that displacement of the second isolation spring over a selected range of movement away from a neutral position generates a greater-than-linear increase in biasing force.

8. An isolator as claimed in claim 1, wherein the second isolation spring has a contact head that is engageable with the shaft connector and that tapers towards a free end.

9. An isolator as claimed in claim 1, wherein the second isolation spring is displaced from a neutral position throughout a selected angular range of displacement between the first rotary drive member and the shaft connector.

10. An isolator as claimed in claim 1, wherein the second isolation spring is a compression spring.

11. An isolator as claimed in claim 1, wherein the motive device is a motor-generator unit.

12. An isolator, comprising:
a shaft connector that is connectable with a shaft of a motive device;
a first rotary drive member that is operatively engageable with at least one second rotary drive member, wherein the first rotary drive member and the shaft connector are rotatable about an isolator axis;
a first isolation spring that is positioned to transfer a torque from the first rotary drive member to the shaft connector, wherein the first isolation spring is a helical torsion spring; and
a second isolation spring that is positioned to transfer a torque from the shaft connector to the first rotary drive member, wherein the second isolation spring is an elastomeric spring.

13. An isolator as claimed in claim 12, further comprising a first driver that co-rotates with the shaft connector, a second driver that co-rotates with the first rotary drive member, and a third driver, wherein torque transfer from the shaft connector to the rotary drive member takes place through the first driver and the second driver, and wherein torque transfer from the rotary drive member to the shaft connector takes place through the third driver and the first driver.

14. An isolator as claimed in claim 12, wherein when the isolator is at rest, the first and second isolation springs are in a state of compression.

15. An isolator as claimed in claim 1, further comprising a first driver that co-rotates with the shaft connector, a second driver that co-rotates with the first rotary drive member, and a third driver, wherein torque transfer from the shaft connector to the rotary drive member takes place through the first driver and the second driver, and wherein torque transfer from the rotary drive member to the shaft connector takes place through the third driver and the first driver.

16. An isolator as claimed in claim 1, wherein when the isolator is at rest, the first and second isolation springs are in a state of compression.
